(19) United States
(12) Patent Application Publication
(10) Pub. No.: US 2018/0364421 A1
(43) Pub. Date: Dec. 20, 2018

(54) FIBER OPTIC CONNECTOR

(71) Applicants: Gloriole Electroptic Technology Corp., Kaohsiung City (TW); Shen Zhen Wonderwin Technology Co., Ltd., Shenzhen City (CN)

(72) Inventors: Ming-Hua CHANG, Kaohsiung City (TW); Yen-Chang LEE, Kaohsiung City (TW)

(21) Appl. No.: 15/714,423

(22) Filed: Sep. 25, 2017

(30) Foreign Application Priority Data
Jun. 16, 2017 (TW) 106208718

(51) Int. Cl. G02B 6/38

(52) U.S. Cl. CPC G02B 6/383; G02B 6/3882; G02B 6/3893; G02B 6/3869; G02B 6/3821; G02B 6/3825; G02B 6/3874

(57) ABSTRACT

A fiber optic connector includes a housing body, a spring push, a connecting plug, a sleeve and a conversion unit. The spring push and the connecting plug are disposed in the housing body. The sleeve is sleeved on the housing body. The conversion unit includes a clamping member and two guide pins. The clamping member is disposed in the housing body, and has two clamping portions. The clamping portions are switchable between a clamping state, in which the guide pins are clamped by the clamping portions and protrude from the connecting plug, and a non-clamping state, in which the guide pins are released from the clamping portions and removed from the connecting plug.

### CROSS-REFERENCE TO RELATED APPLICATION

This application claims priority to Taiwanese Patent Application No. 106208718, filed on Jun. 16, 2017.

### FIELD

The disclosure relates to a connector, and more particularly to a fiber optic connector.

### BACKGROUND

Referring to FIG. 1, a male-type fiber optic connector 11 and a female-type fiber optic connector 12 are inserted into an MPO (Multi-fiber push on) adaptor 10. The MPO adaptor 10 has a male hole 101 and a female hole 102 opposite to the male hole 101. The male-type and female-type fiber optic connectors 11, 12 are respectively inserted into the male and female holes 101, 102. The difference of the male-type fiber optic connector 11 from the female-type fiber optic connector 12 resides in that the male-type fiber optic connector 11 has two parallel spaced-apart guide pins 111 protruding therefrom.

In order to match with the MPO adaptor 10, fiber optic connectors have to be male-type and female-type fiber optic connectors 11, 12, that is to say two different types, thereby increasing the fabrication cost. On the other hand, for installing fiber networks by using the MPO adaptor 10, it is required to repeatedly make selection between the male-type and female-type fiber optic connectors 11, 12, which may cause inconveniences and adversely affect installation efficiency.

### SUMMARY

Therefore, an object of the disclosure is to provide a fiber optic connector that is switchable between male and female plug configurations.

According to the disclosure, a fiber optic connector includes a housing unit, a connecting plug, a sleeve and a conversion unit.

The housing unit includes a housing body and a spring push. The housing body has front and rear ends, and an accommodating space between the front and rear ends. The spring push is disposed in the accommodating space proximal to the rear end.

The connecting plug is disposed in the accommodating space proximal to the front end.

The sleeve is sleeved on the housing body.

The conversion unit includes a clamping member and two guide pins. The clamping member is disposed in the accommodating space between the connecting plug and the spring push, and has two clamping portions spaced apart from each other. The guide pins detachably extend through the connecting plug and are positioned respectively in the clamping portions of the clamping member. Each of the guide pins has a protruding end protruding from the connecting plug and distal from the clamping member.

The clamping portions are switchable between a clamping state, in which each of the guide pins is clamped by one of the clamping portions and protrude from the connecting plug, and a non-clamping state, in which each of the guide pins is released from one of the clamping portions and removed from the connecting plug.

### BRIEF DESCRIPTION OF THE DRAWINGS

Other features and advantages of the disclosure will become apparent in the following detailed description of the embodiment with reference to the accompanying drawings, of which:

FIG. 1 is an exploded perspective view of an existing MPO adaptor and existing male-type and female-type fiber optic connectors;

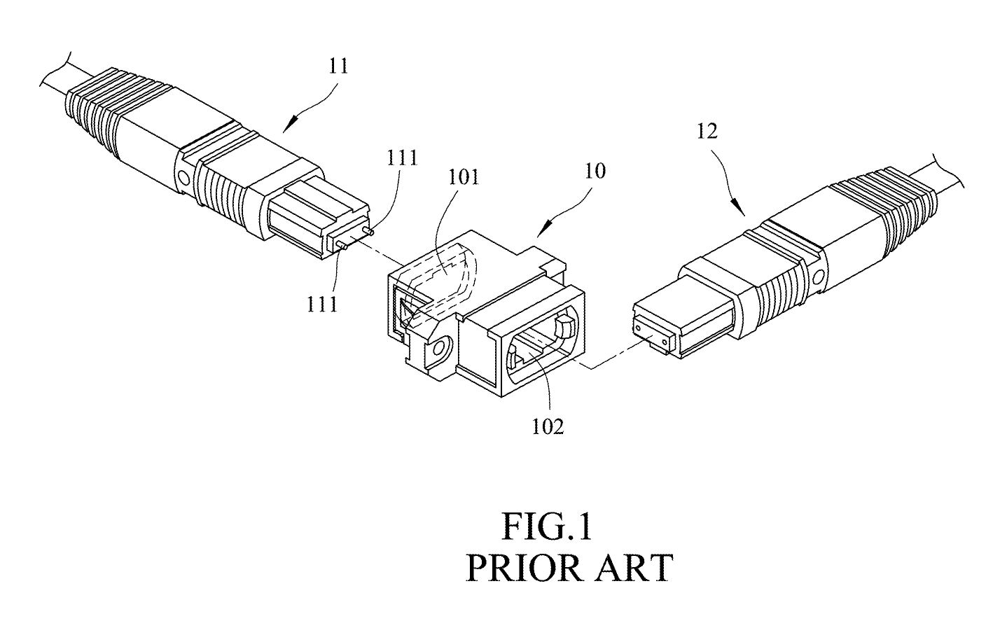

FIG. 2 is an exploded perspective view, illustrating a fiber optic connector according to an embodiment of the present disclosure;

FIG. 3 is a perspective view of the embodiment;

FIG. 4 is a sectional view of the embodiment;

FIG. 5 is a perspective view of the embodiment, illustrating a clamping member of the fiber optic connector;

FIG. 6 is a fragmentary perspective view of the embodiment, illustrating a switching member of the fiber optic connector being inserted into the clamping member of the fiber optic connector;

FIG. 7 is a fragmentary perspective view of the embodiment, illustrating guide pins of the fiber optic connector being clamped by and removed from the clamping member by insertion of the switching member;

FIG. 8 is a perspective view of the embodiment, illustrating the fiber optic connector having a female plug configuration;

FIG. 9 is a fragmentary perspective view of the embodiment, illustrating that the guide pin is removed from the clamping member by using the switching member;

FIG. 10 is a perspective view of the embodiment, illustrating adjustment of a connection key of the fiber optic connector; and

FIG. 11 is a perspective view of the fiber optic connector in thermal plug configuration for assembly with an MPO adaptor.

### DETAILED DESCRIPTION

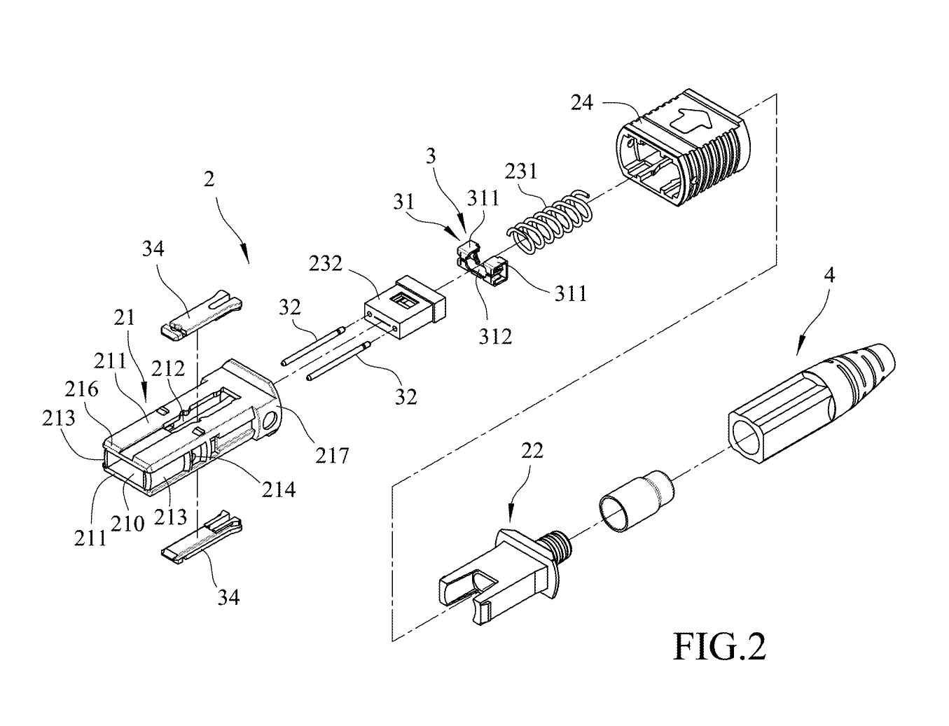

Referring to FIGS. 2 to 4, a fiber optic connector according to an embodiment of the present disclosure includes a housing unit 2, a connecting plug 232, a compression spring 231, a sleeve 24 and a conversion unit 3.

The housing unit 2 includes a housing body 21 and a spring push 22. The housing body 21 has front and rear ends 216, 217, and an accommodating space 210 between the front and rear ends 216, 217. The spring push 22 is disposed in the accommodating space 210 proximal to the rear end 217, and is suitable for insertion of a fiber optical cable (not shown). In this embodiment, the housing body 21 has two spaced-apart top and bottom walls 211, two sliding grooves 212 (only one is shown) respectively formed in outer surfaces of the top and bottom walls 211 and extending from the front end 216 to the rear end 217 of the housing body 21, two lateral walls 213 each connecting between the top and bottom walls 211, and two through holes 214 respectively formed in the lateral walls 213. The sleeve 24 is sleeved on the housing body 21.

The connecting plug 232 is disposed in the accommodating space 210 proximal to the front end 216.

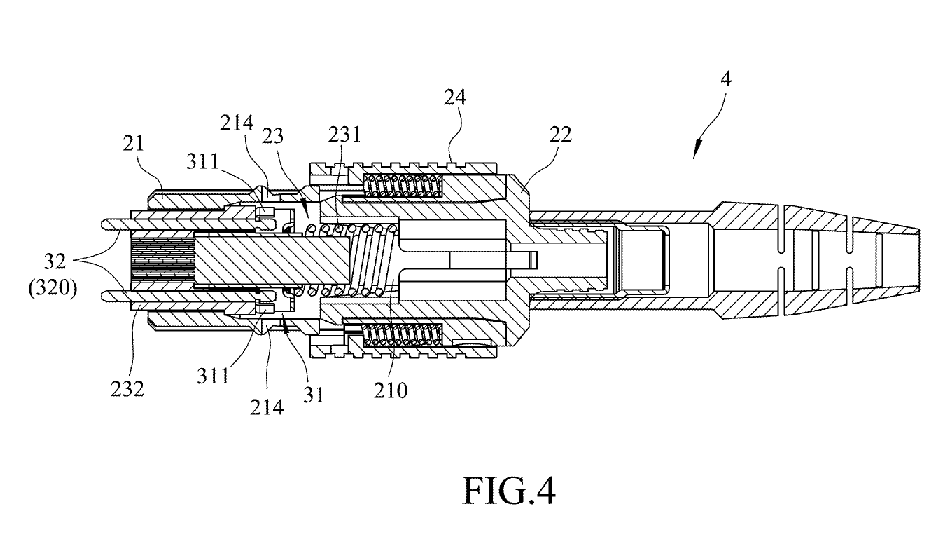

The compression spring 231 is disposed between and abuts against the spring push 22 and the clamping plug 232. In this embodiment, the connecting plug 232 is a connector plug ferrule. The fiber optic cable (not shown) extends through the spring push 22 via a boot 4 connected to the spring push 22, and is connected to a ribbon cable within the connecting plug 232 (see FIG. 4). When the fiber optic connector of the present disclosure is plugged into an MPO adaptor (not shown), the compression spring 231 is compressed and generates a biasing force to bias the connecting plug 232 outward and toward the MPO adaptor. With the biasing force, the ribbon cable in the connecting plug 232 can be assuredly placed in contact with another ribbon cable (not shown) to be connected to the ribbon cable in the connecting plug 232.

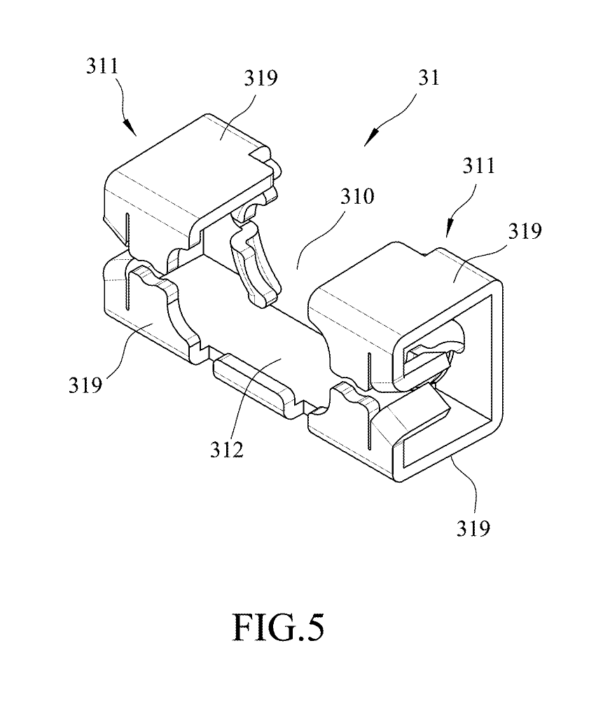

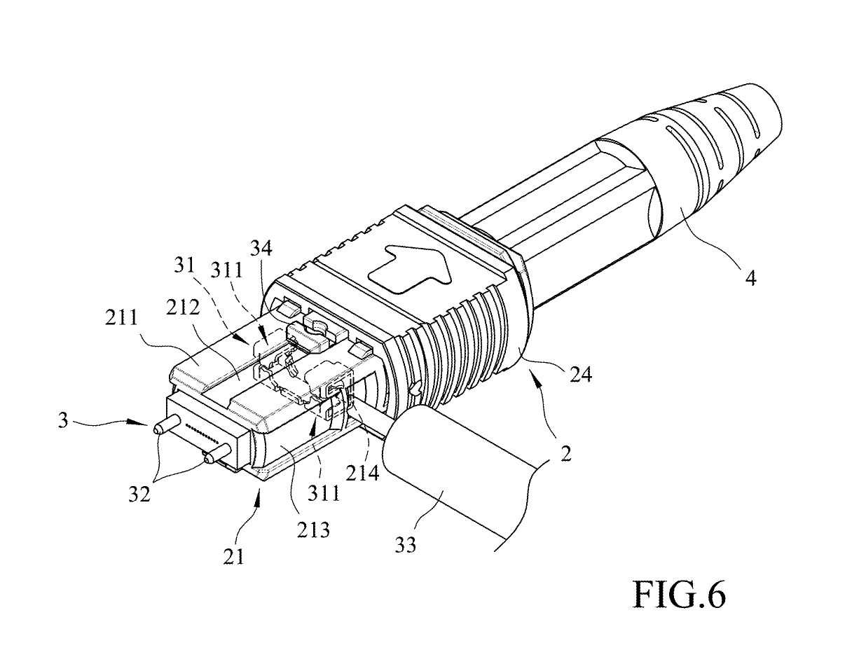

Referring to FIGS. 5 and 6, in combination with FIGS. 2 and 4, the conversion unit 3 includes a clamping member 31, two guide pins 32, a switching member 33 and two connection keys 34. The clamping member 31 is disposed in the accommodating space 210 between the connecting plug 232 and the spring push 22, and has two clamping portions 311 spaced apart from each other, and a bridging portion 312 bridging the clamping portions 311. The positioning and bridging portions 311, 312 of the clamping member 31 cooperatively define a passage 310 for extension of the compression spring 231. As such, the compression spring 231 is supported and positioned by the clamping member 31, and the clamping member 31 is urged to abut against the connecting plug 232 by the compression spring 231. The guide pins 32 detachably extend through the connecting plug 232 and are positioned respectively in the clamping portions 311 of the clamping member 31.

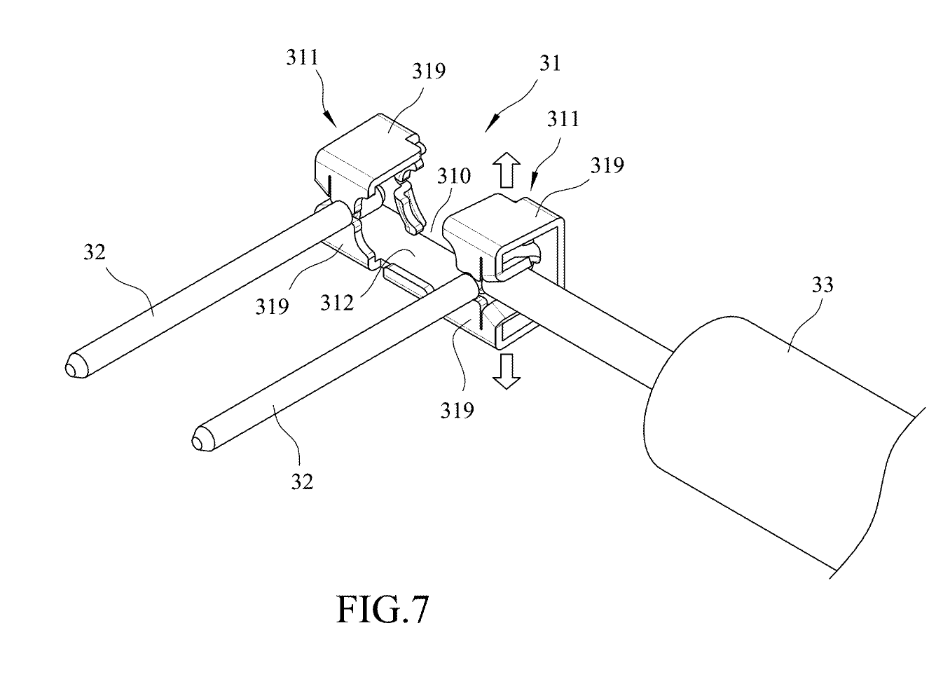

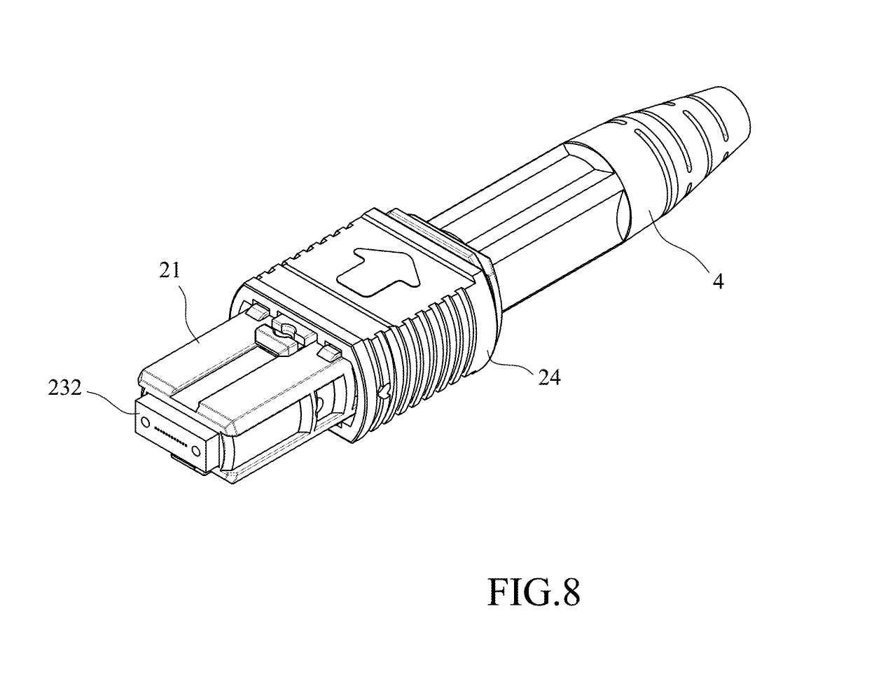

Referring to FIGS. 7 and 8, in combination with FIG. 6, the opposite through holes 214 in the housing body 21 are disposed at positions corresponding to the clamping portions 311 of the clamping member 31, respectively. The clamping member 31 is made from a resilient material, such as a metal. Each clamping portion 311 of the clamping member 31 has two confronting clamping segments 319. The clamping portions 311 are switchable between a clamping configuration, in which each of the guide pins 32 is clamped by one of the clamping portions 311 and protrude from the connecting plug 232, and a non-clamping configuration, in which each of the guide pins 32 is released from one of the clamping portions 311 and removed from the connecting plug 232. The switching member 33 is extendible through either one of the through holes 214 to be wedged between the clamping segments 319 of either one of the clamping portions 311. When the switching member 33 is wedged between the clamping segments 319 of a respective one of the clamping portions 311 (see FIG. 7), the switching member 33 applies a force to deformingly move the clamping segments 319 of the respective clamping portion 311 away from each other, thereby placing the same in the non-clamping configuration from the clamping configuration. As such, the guide pins 32 are released from the clamping member 31 and removed from the connecting plug 232. The connecting plug 232 therefore has a female plug configuration (see FIG. 8).

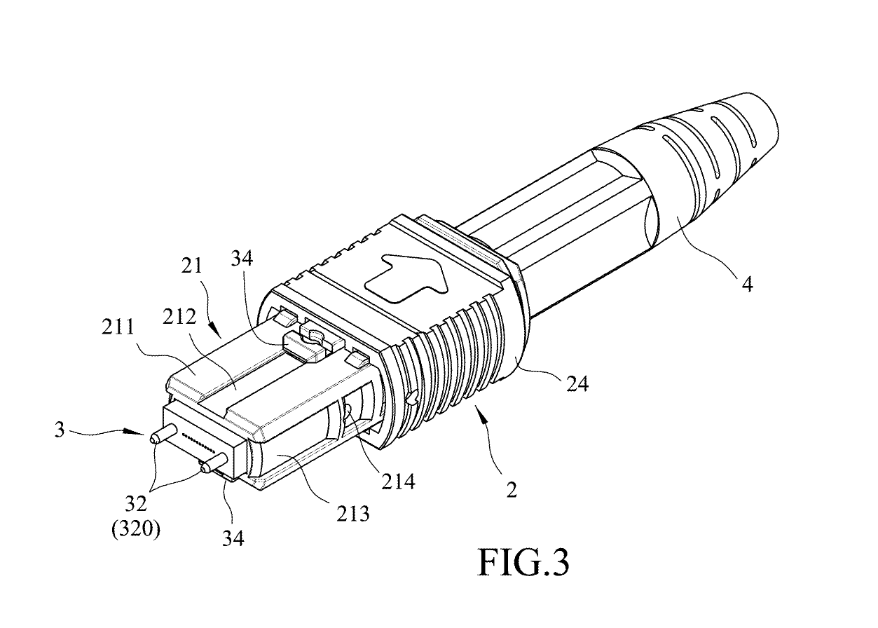

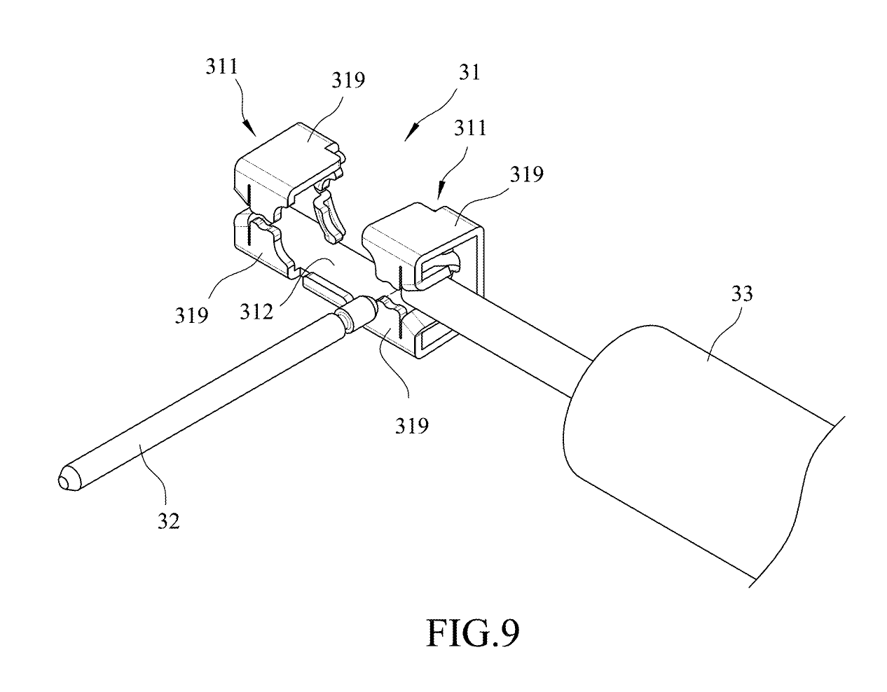

Referring to FIG. 9, in combination with FIG. 8, when the connecting plug 232 is needed to be converted from the female plug configuration into a male plug configuration, the clamping portions 311 maybe switched to the non-clamping configuration from the clamping configuration by using the switching member 33. During the operation to wedge the switching member 33 in between the clamping segments 319, one of the guide pins 32 is placed between the clamping segments 319. When the switching member 33 is moved away from the clamping segments 319, the clamping segments 319 are resilient to move back toward each other, and clamp and position the guide pin 32 therebetween. When the guide pins 32 are clamped and positioned in the respective clamping portions 311, the guide pins 32 have protruding ends 320 protruding from the connecting plug 232 and distal from the clamping member 31 (see FIGS. 3 and 4) such that the connecting plug 232 has a male plug configuration.

Note that the clamping member 31 should not be limited to the configuration as being illustrated in this embodiment. It maybe in any shape as long as the clamping segments 319 can be moved away from each other when being wedged by the switching member 33.

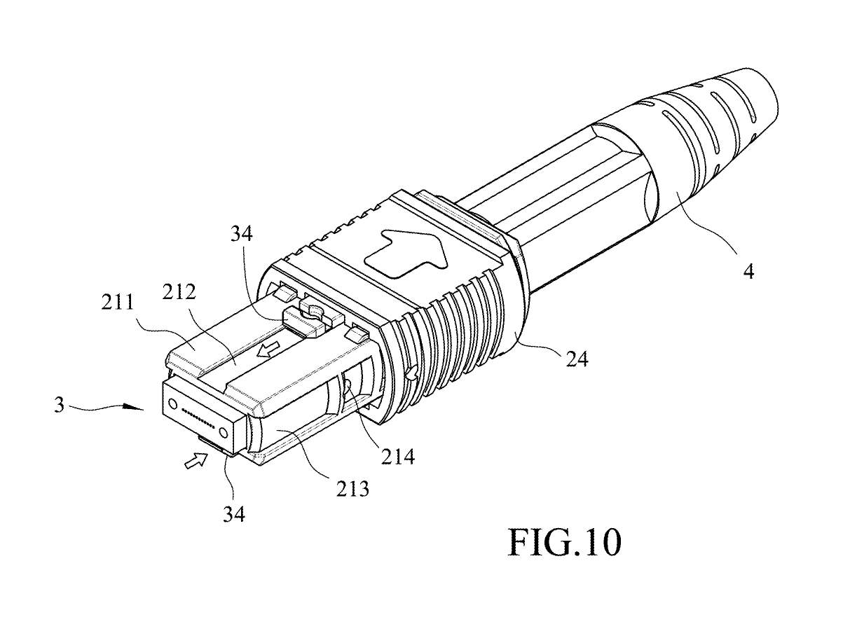

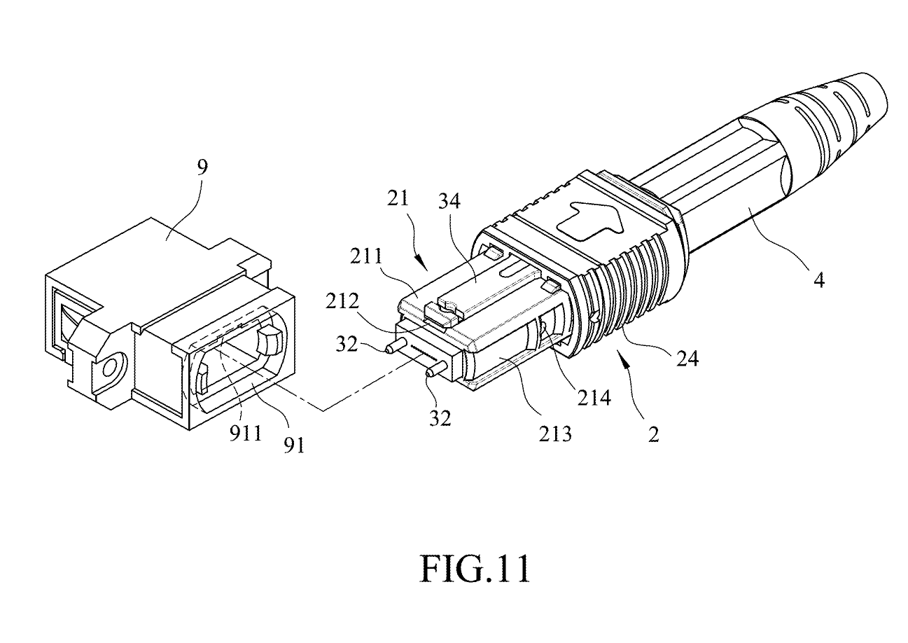

Referring to FIGS. 10 and 11, the connection keys 34 are respectively and slidably disposed in the sliding grooves 212. The connection keys 34 are slidable relative to the sleeve 24 between a concealed position, where the connection keys 34 are concealed by the sleeve 24, and a non-concealed position, where the connection keys 34 are exposed from the sleeve 24. In this embodiment, the fiber optic connector of the present disclosure is an MPO connector suitable for connection with an MPO adaptor 9. The MPO adapter 9 has an insertion hole 91 and a key slot 911 communicating with the insertion hole 91. Aside from adjustment of the connecting plug 232 between the male and female plug configurations, it is necessary to adjust the position of one of the connection keys 34 to match with the key slot 911 of the MPO adaptor 9 in order for the fiber optic connector of the present disclosure to be inserted into the insertion hole 91 of the MPO adaptor 9. Therefore, the connection keys 34 are arranged to be slidable in the respective sliding grooves 212. When one of the connection keys 34 slides to the non-concealed position to match with the key slot 911 of the MPO adaptor 9, the fiber optic connector of the present disclosure can be inserted into the insertion hole 91 of the MPO adaptor 9.

To sum up, by virtue of the switching member 33 being manipulatable externally of the housing body 21 to operate the clamping member 31 for attaching the guide pins 32 to the connecting plug 232, or detaching the guide pins 32 from the connecting plug 232, the fiber optic connector of the present disclosure is convertible between the male and female plug configurations.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A fiber optic connector comprising:
a housing unit including
a housing body having front and rear ends, and an accommodating space between said front and rear ends, and
a spring push disposed in said accommodating space proximal to said rear end;
a connecting plug disposed in said accommodating space proximal to said front end;
a sleeve sleeved on said housing body; and
a conversion unit including
a clamping member disposed in said accommodating space between said connecting plug and said spring push, and having two clamping portions spaced apart from each other, and
two guide pins detachably extending through said connecting plug and positioned respectively in said clamping portions of said clamping member, each of said guide pins having a protruding end protruding from said connecting plug and distal from said clamping member;
wherein said clamping portions are switchable between a clamping configuration, in which each of said guide pins is clamped by one of said clamping portions and protrudes from said connecting plug, and a non-clamping configuration, in which each of said guide pins is released from one of said clamping portions and removed from said connecting plug.

2. The fiber optic connector as claimed in claim 1, wherein:
said housing body further has two opposite through holes at positions corresponding to said clamping portions of said clamping member; and
said conversion unit further includes a switching member extendible through either one of said through holes to apply a force and to deformingly move either one of said clamping portions to the non-clamping configuration from the clamping configuration.

3. The fiber optic connector as claimed in claim 2, wherein each of said clamping portions of said clamping member has two confronting clamping segments, said switching member being able to wedge between said clamping segments, said clamping segments being movable away from each other when being wedged by said switching member, and being resilient to move back toward each other when said switching member is moved away from said clamping segments.

4. The fiber optic connector as claimed in claim 2, wherein:
said housing body further has two spaced-apart top and bottom walls, two sliding grooves respectively formed in outer surfaces of said top and bottom walls and extending from said front end to said rear end of said housing body, and two lateral walls each connecting between said top and bottom walls; and
said conversion unit further includes two connection keys respectively and slidably disposed in said sliding grooves, said connection keys being slidable relative to said sleeve between a concealed position, where said connection keys are concealed by said sleeve, and a non-concealed position, where said connection keys are exposed from said sleeve.

5. The fiber optic connector as claimed in claim 4, wherein said through holes are respectively formed in said lateral walls.

6. The fiber optic connector as claimed in claim 1, wherein said clamping member further has a bridging portion bridging said clamping portions.

7. The fiber optic connector as claimed in claim 6, further comprises a compression spring, said connecting plug being a connector plug ferrule for insertion of said guide pins, said compression spring being disposed between and abutting against said spring push and said clamping plug, and said positioning and bridging portions of said clamping member cooperatively defining a passage for extension of said compression spring.

8. The fiber optic connector as claimed in claim 6, wherein said clamping member is urged to abut against said connecting plug by said compression spring.

9. The fiber optic connector as claimed in claim 1, further comprising a boot connected to said spring push.
